(19) United States
(12) Patent Application Publication
(10) Pub. No.: US 2001/0049644 A1
(43) Pub. Date: Dec. 6, 2001

(54) Method for customizing and purchasing a tire

(76) Inventors: Philip B. Webb, Greenville, SC (US); Mathew H. Aaron, Greenville, SC (US); John D. Adamson JR., Simpsonville, SC (US); William C. Baker, Greenville, SC (US); Wayne Edgar Powell JR., Piedmont, SC (US)

Correspondence Address: Alan A. Csontos, Esquire, Michelin Intellectual Property Department, P.O. Box 2026, Greenville, SC, 29602-2026, US

(21) Appl. No.: 09/827,687

(22) Filed: Apr. 6, 2001

Related U.S. Application Data
(63) Continuation of application No. PCT/US00/12859, filed on May 11, 2000.

(51) Int. Cl. G06F 17/60

(52) U.S. Cl. 705/27

(57) ABSTRACT

A method for customizing a tire and ordering for purchase a custom tire allows a purchaser to select certain features for a tire, for example, colored rubber for certain locations on the tread, using computer-based communication with a server system. The purchaser is presented with choices of features to incorporate in a tire, and is shown images representing a tire having the selected features. At the purchaser's request, an electronic order is formed and presented to the manufacturing entity, which executes the order via an automated manufacturing process to build, cure, and ship the tire or tires to the purchaser. The manufacturing entity automatically reports certain events to the server system, which generates and sends electronic messages to the purchaser to inform him or her of the progress of the order.

### BACKGROUND AND SUMMARY OF THE INVENTION

The present invention concerns a method for utilizing computer communication to allow a purchaser to customize and order a tire. More particularly, the present invention also provides a method for allowing a purchaser to select and specify certain features to be included in a tire, for example, color tread rubber, and to create an electronic order for a tire according to the specified features, which is then manufactured by computer-aided manufacturing process.

Computer-based communication, for example, through the Internet, has opened broad and quick access to information and opportunities to exchange information, including communications for engaging in commerce. The ability to present information, including text, images, and sound allows businesses to display a virtual store in which visitors may browse through a computer connection. The visitor, through actions using the computer, has the ability to choose the content of information to be viewed through self-directed movements by clicking the screen displayed icons or buttons with a mouse or keyboard action, which sends various pages or screens for view on the visitor's computer monitor.

The present invention incorporates computer communication capabilities to provide a method for a customer to communicate with a server system to design certain features of a tire and submit an order to purchase the tire.

According to another aspect of the invention, a computer-aided manufacturing process receives and executes the order from the server system and a tire having the customer selected features is built and vulcanized, and then delivered to the customer.

According to a preferred embodiment of the invention, the selected feature is colored tread rubber for incorporation in certain portions of the tread. According to other aspects of the invention, the selected feature is a performance characteristic of the tread that may be modified by a change in the tread rubber compound. For example, tire performance for snow traction, wet traction, highway speed driving, local or in-town driving, or the like, may be optimized by incorporation of an appropriate rubber compound. Alternatively, or in addition, certain personalizing features may be added to the tire, for example, the purchaser's name, a personal message, or a decorative pattern or color added on the sidewall.

According to the invention, a purchaser or customer uses a computer to contact a server system by way of the Internet or other communication network. The server system presents to the purchaser, among other things, the information for selecting or specifying certain elements for the tire and for ordering a tire according to the specified elements.

According to one embodiment of the invention, a purchaser desiring to customize a tire is requested or prompted to a screen having a representation, preferably an image, of a tire. The tire image includes at least one zone or portion that is indicated to be customizable, that is, available for the purchaser to specify certain features. Other images on the screen display selectable elements that may be applied to the selected zone or zones. The purchaser is guided to select a tire portion and an element to be applied to that portion. Responsive to signals indicating a selection of a portion and element, the screen indicates that the selected element has been applied to the tire.

For features that actually result in a visible change to the tire, for example, colored tread rubber, the image of the tire is modified to show the selected element (color) on the selected tire portion. For features that are not readily visible, as for tread compound changes for performance, some other indication, textual, crosshatching, or highlighting the portion, for example, may be given.

As mentioned, according to a preferred embodiment, the selectable feature is colored tread rubber. Colored rubber can be added to the tread or to the sidewall of the tire to add to the ornamental or aesthetic aspects to the tire.

According to a preferred embodiment of the invention, the purchaser selects a color by clicking a pointer on one of a plurality of color choices to add the color to the tread portion. Various methodologies could be used to perform this function, for example, click and carry (where a first click selects the color and the immediately following click applies the color to a portion), click and drag (where a downward click selects the color, and the mouse button is held down until the arrow is placed on the selected portion), etc.

A preferred method includes sets of color choices arranged for each tread portion and a matrix of color rows by portion columns displayed between the color sets and the tire image. A click on a color in each of the sets transfers the selected color to the appropriate row of the matrix. Once the purchaser transfers a color to each row, a column and row position corresponding to a selected color and portion is clicked, which transfers the selected color to the selected portion. The image of the tire is modified by the server to display the color applied to the tread, which provides the purchaser a visual representation of the designed tire.

According to another aspect of the invention, the purchaser is allowed to continue selecting portions and colors, changing and/or rearranging the color choices, and to view, with each step, the image of a tire modified to have the selected colors on the selected portions. A communication or signal by the purchaser indicating a desire to order the designed tire locks in the choices for inclusion in the tire order.

The purchaser may be prompted to select a model or type of tire for design at the beginning of the feature selection and specification process. Alternatively, the manufacturer may offer only certain tire models for customization.

At some point in the order formation, the purchaser is prompted to identify the size of the tire (e.g., P245/45 R 17) appropriate for his or her vehicle, and to indicate a quantity of tires for manufacture and purchase. According to the invention, the purchaser can order four identical tires, relying on a single design, or may design and order four different tires, if desired.

Another aspect of the invention is a prompt that directs the purchaser who needs assistance to a fitment site to help determine the appropriate size tire for his or her vehicle. The fitment site includes a database of vehicle manufacturer recommended tire sizes for vehicles. The fitment site may also include data for recommended tire models for the vehicle.

According to yet another aspect of the invention, information identifying the purchaser is gathered, including name, address, credit card information to complete the financial aspects of the purchase, and an address to ship the tire.

The cost for manufacturing and shipping the tire is calculated, including taxes and applicable government-mandated disposal fees.

The purchaser's credit card account is requested to authorize a charge for the order, and if authorized, the order process continues.

All of the information related to the order is compiled into an electronic order file, which is assigned an order identification number, which is returned to the purchaser with a confirmation of the order. The order file is then electronically delivered to or made available for the manufacturing entity. The order file is also transmitted to a customer service group to serve as a contact for the customer for questions about the tire or the order. After manufacture, the purchaser's credit card account is charged and the tires are shipped.

According to the invention, after the order is received by the manufacturing system, the manufacturing system uses the order to generate a manufacturing specification for the tires to be built according to the order. The manufacturing system also organizes tire manufacturing specifications for all orders received according to common parameters, such as tire model and/or type for controlling the manufacturing process efficiently. The manufacturing specification is provided to an automated tire manufacturing machine. An example of a machine capable of automated operation has a plurality of extruders, each dedicated for stripwinding one of a plurality of components corresponding to the selectable features. The machine selects according to the order an extruder having a component for the selected feature, and extrudes and stripwinds the component for incorporation in an uncured tire. After the tire has been built, including all the selected features according to the order, the tire is then placed in a mold press and vulcanized or cured.

After vulcanization, the tire or tires are prepared for shipping, and given to a shipper for delivery to the purchaser.

The manufacturing system will automatically generate and send electronic messages to report certain events to server system. The server system generates email or other electronic messages for the purchaser to keep the purchaser informed during the manufacturing process. When the order is retrieved by the manufacturing system, a message that the order has been received at the factory will be sent. When the tire order has been filled, that is, the tires built and vulcanized, a message indicating a planned ship date will be sent. After the tire order is given to the carrier, a message that the tires have been shipped will be sent. Thus, the purchaser can track the progress of the order.

The purchaser will also be able to contact the server system directly, and using the order identification number, can obtain progress information from the server. The messages will also be sent to the customer service system. The purchaser will also have the ability to contact the customer service system to track these milestones.

### BRIEF DESCRIPTION OF THE DRAWINGS

The invention will be better understood through the following detailed description in conjunction with the appended drawings, in which:

FIG. 1 is a schematic of a communication network supporting the invention;

FIG. 2 is a flow diagram showing the method steps of the invention; and

FIG. 3 is a representation of a screen image for one embodiment for performing the selection of features for a tire.

### DETAILED DESCRIPTION OF THE INVENTION

The invention provides a method for a purchaser to select certain features for inclusion in a tire to be made for that purchaser, that is, to specify selected features for a tire and purchase a customized tire through interactive computer communication.

The present invention is described below in conjunction with using computer communication over the Internet. The description is meant to be illustrative rather than limiting. The Internet, comprising a vast number of interconnected computers and computer networks, is a convenient resource for establishing communication between a user's computer and various computer servers. However, any suitable computer communication means, including direct connection by telephone line, wireless communication links, or the like, should be understood as being included in the following description.

In addition, as further described below, colored rubber in the tread is a preferred feature for custom selection by the purchaser, but other features, for example, adding ornamental elements to the sidewall, attractive figures or the like, is also possible. Further, as described below, functional characteristics for the tread, or other elements that from an engineering point of view may be suitable for selection by a customer for incorporation in a tire, may also be the subject of the invention.

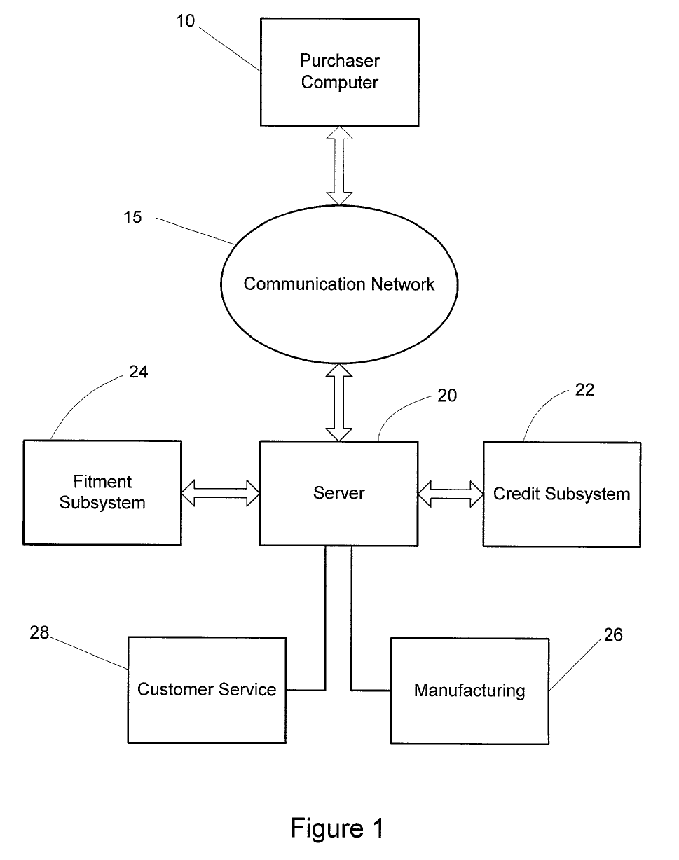

FIG. 1 is a schematic diagram of a communication system for the method of the invention. A purchaser's computer 10 electronically links to a system server 20 over a communication network 15, preferably over the Internet, or more specifically, the World Wide Web. The computer 10 could use a browser software package to locate and connect to the server 20 over the Internet. Alternatively, the computer 10 could contact the server directly over a telephone line or wireless cellular connection. Of course, other communication links that allow for information exchange between computers could be substituted. The server 20 is illustrated as a single box, but, as is known, typically comprises one or more server machines linked together. The server 20 supports a plurality of electronic documents or pages in HTML or another markup format that are transmittable to the purchaser's computer for display on the monitor screen.

The server 20 transmits information to the purchaser's computer 10 to allow the purchaser to view and custom select features for one or more tires, and to order for purchase the customized tires, as explained in greater detail below.

The server 20 includes links to subsystems, including a credit authorization system 22 and a subsystem 24 containing a tire fitment guide. The server 20 will also allow the purchaser to connect to a subsystem to aid in determining the correct fitment for the tire, that is, allow the purchaser to identify the correct size tire for his vehicle.

According to an alternative embodiment, a tire selection subsystem, which may be incorporated in the tire fitment subsystem, could provide information for assisting the purchaser to select a tire model for his vehicle.

The server 20 generates the order file, as described below, and makes the order file available for the manufacturing system 26 to retrieve. The order file is also sent to or made available for a customer service entity 28 to track and service the order. An order identifier number is assigned, and sent to the purchaser.

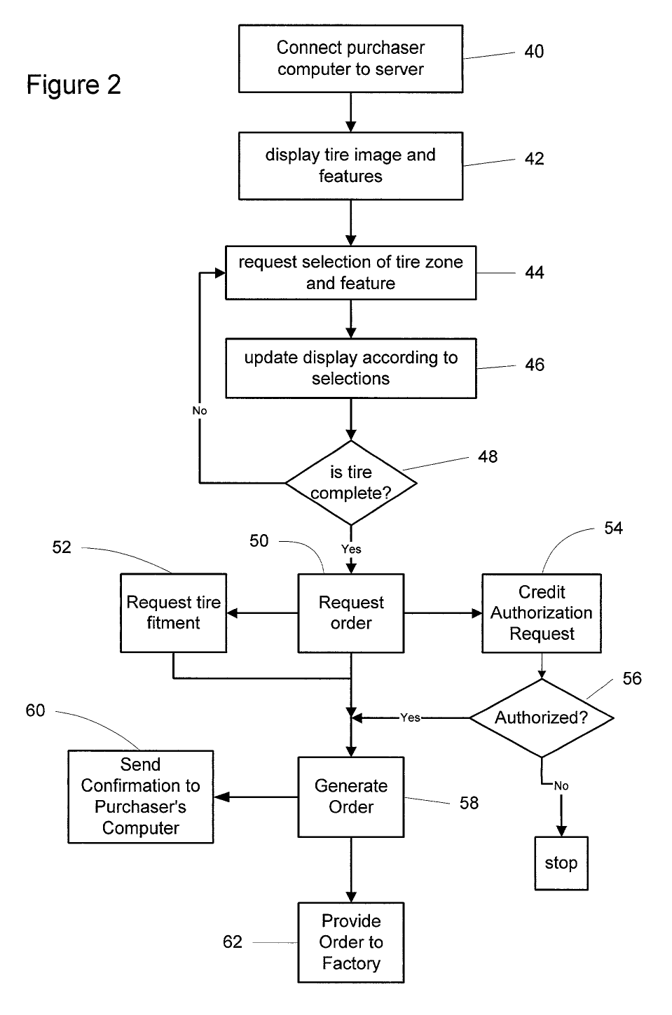

FIG. 2 is a flow diagram of the steps of a preferred embodiment of the invention. In a first step 40, the purchaser computer contacts the server to establish communication. The server transmits an electronic document or page to the purchaser's computer that includes information inviting the purchaser to select certain elements for a customized tire and purchase the customized tire.

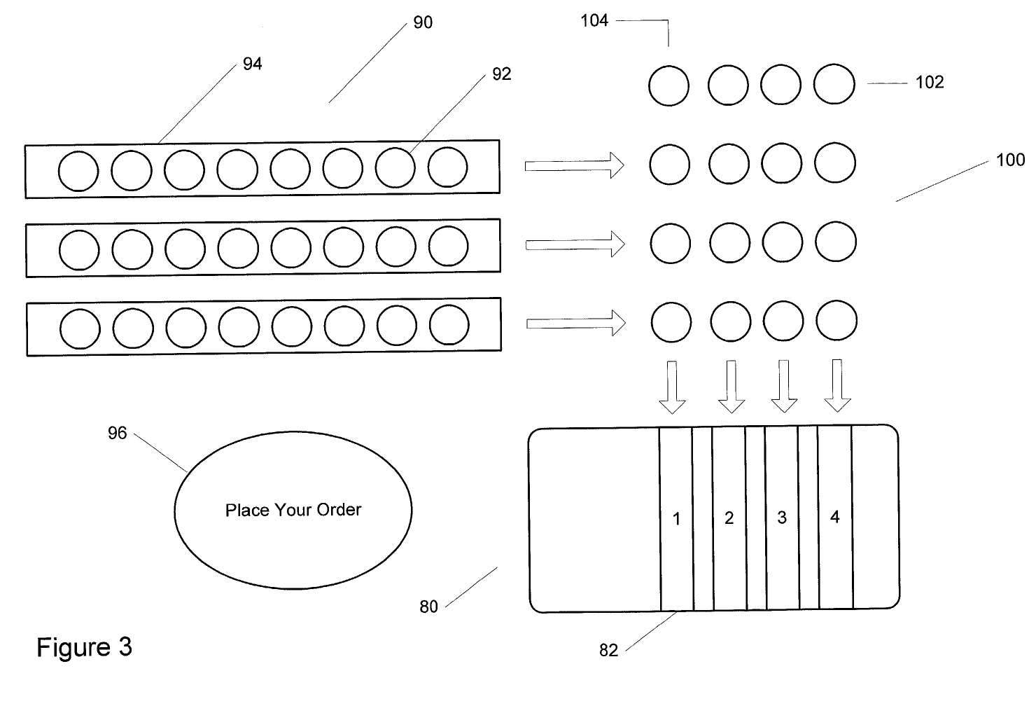

A signal or communication received from the purchaser indicating a desire to customize a tire causes the server to send a different page illustrating a tire and selectable design features to the purchaser computer for display thereon, shown as box 44. FIG. 3 illustrates schematically one form such a page may take. The image of the tire 80 will indicate that designated zones or portions 82 of the tire 80 are available for custom feature selection. The default color for all zones 82 and for the non-selectable portions 83 of the tire is black. In the example shown, the color of the remaining tread portion 83 is black and is not offered for color selection by the purchaser. The illustrated tire 80 has four zones 52 corresponding to ribs of the tire and a portion of the shoulder, but this is for the purposes of this description only and does not represent a preferred quantity of selectable portions. The actual quantity of selectable zones may depend, for example, on the tread design of the tire if tire ribs are used to differentiate zones, or may simply be a division of the tread into a predetermined number of equally or unequally sized portions.

A plurality of color selections 90 is also displayed. The quantity of color choices is a matter of engineering or business choice. Each color is represented in FIG. 3 by a circle 92.

The purchaser can apply color to a selected zone 82 in a number of ways. For example, a click and drag routine allows the purchaser to click on a selected color and drag it to the selected zone. An alternative procedure allows a first click on a color 92 to hold the color until a next click on a zone 82 applies it to the zone. Another alternative where only few colors are offered is to allow sequential clicks on the selected zone 82 to display sequentially the available color choices on the zone.

A preferred method is shown in FIG. 3. Sets 94 of color choices 92 are arranged in rows for each tread portion and a matrix 100 of color rows 102 by tread columns 104 is displayed between the color sets and the tire image. A click on a color 92 in each of the sets 94 transfers the selected color to the matrix 100 in the appropriate row 102. Once the purchaser selects a color for each row, the matrix position (shown by circles 106) corresponding to a selected color and tread position combination is clicked, which transfers the selected color to the selected portion. The image of the tire 80 is modified by the server to display the color applied to the tread to provide the purchaser an image of the designed tire.

The display of the tire 80 is modified each time a color 92 and zone 82 combination is selected to show the tire with the selected colors in the selected zones. The purchaser is thus able to view a representation of the designed tire for consideration. The purchaser is allowed to continue selecting color and zone, and to change previously selected zones, until a signal or communication is received indicating that the purchaser has completed the design of the tire and is ready to order the tire. The purchaser may send such a signal by clicking on the order icon 96.

According to another aspect of the invention, the purchaser may select performance-related characteristics of the tread that may be incorporated in the tire by using a particular tread compound. As is known, different tread compounds can provide a different balance of performance characteristics, being optimized, for example, for highway driving, traction in wet conditions, or traction in snow. The purchaser specifies the main or primary driving condition for the vehicle (and hence the tires), e.g., highway, city, hill or mountainous, all-weather, winter, wet (rainy climates), hot weather, and a tread compound optimized for that condition can be incorporated in the tire.

Where a feature that is not visibly distinguishable, such as tread compound, is selected, some indication such as a textual display, or a visual representation such as cross-hatching, highlighting, or the like, may be used to indicate that the selected feature has been applied to the tire. Performance characteristic and color selections are not mutually exclusive and may be incorporated in the same custom tire procedure.

Returning to FIG. 2, the purchaser may then proceed to order the customized tire or tires. The step of requesting the order 50 is performed in the illustrated embodiment by the icon 96.

The purchase order is completed by the purchaser providing certain information, including name, address, shipping address (if different), credit card number, number of tires, and tire size. If the purchaser does not know the appropriate size tire, he will be directed 52 by the server to a subsystem having a data base for identifying recommended tire sizes for vehicles.

A credit subsystem will verify the credit information provided by the purchaser to obtain authorization 54 to charge the purchaser's account. If the charge is authorized, the server allows the purchaser to continue. If the charge is not authorized, the process stops, and the purchaser is asked to verify the credit information or provide another credit card number to continue.

The order is generated 58 by organizing the information related to the order into an electronic file, which is assigned an order number. A communication 60 confirming the receipt of the order, and including the order number is returned to the purchaser by email or other convenient means.

The order file is made available 62 to the manufacturing system, which will retrieve and execute the order. A tire according to the custom design is built and vulcanized or cured, and subsequently shipped to the purchaser. By the term “built” is meant assembling the tire components, uncured rubber compounds, reinforcements, fabric plies, and the like, into an uncured tire. As is understood in the art, through vulcanization the uncured rubber takes on its final characteristics or attributes.

Manufacture of a custom tire advantageously is done by an automated manufacturing system as described below. Such a system conveniently uses the order data stored for the customized tire in a computer-aided manufacturing system. The system uses the order data to set up parameters controlling the manufacturing system.

According to the invention, the manufacturing system includes an adaptation system for generating a manufacturing specification from the tire order file. The adaptation system has a generic specification that covers the tire order combinations made available to the purchaser. The adaptation system adapts the generic specification to include the elements contained in the tire order file to generate a manufacturing specification for tires according to the order. The manufacturing specification is delivered to the computer-aided manufacturing system.

Advantageously, the customized tire is built on a machine similar to the machine disclosed in U.S. Pat. No. 5,908,531, which is incorporated herein by reference, having different extruders operated by one or more robots to wind strips of rubber around the uncured tire being built thereon. The rib 52 that forms a zone 1, for example, is made by a first extruder stripwinding the selected colored raw rubber compound. The ribs 52 of the other zones 2-4, are then made by other extruders stripwinding each of those selected colored raw rubber compounds. If the color for any one of the ribs 52 is selected to be black, then the machine (described in U.S. Pat. No. 5,908,531) uses an extruder for black rubber for that rib, and may use the same extruder for the remaining portion 53 of the tread if appropriate. A different extruder may be used if, for example, a wider extruded strip is desired. Reference is also made to U.S. Pat. No. 5,261,795 and No. 5,655,891, showing suitable volumetric extruders for use in the process. The extruders work successively to extrude the appropriate selected rubber in the desired place on the tire. It may be possible to operate more than one extruder simultaneously, depending on the tire building machine used.

According to the invention, after the order is received by the manufacturing system a manufacturing specification is generated by the adapter system. The manufacturing specification is provided to an automated machine as described above. The machine has a plurality of extruders, each dedicated for stripwinding one of a plurality of components corresponding to the selectable features. The machine selects according to the order an extruder having a component for the selected feature, and extrudes and stripwinds the component for incorporation in an uncured tire. After the tire has been built, including all the selected features according to the order, the tire is then placed in a mold press and vulcanized or cured.

After vulcanization, the tire or tires are prepared for shipping, and given to a shipper for delivery to the purchaser.

The manufacturing system will automatically generate and send electronic messages to report certain events to the server system during the manufacturing process. The server system sends electronic messages (e.g., email) to the purchaser and makes the information available for inquiry by the purchaser. When the order is retrieved by the manufacturing system, a message that the order has been received at the factory will be sent. When the tire order has been filled, that is, the tires built and vulcanized, a message indicating a planned ship date will be sent. After the tire order is given to the carrier, a message that the tires have been shipped will be sent. Thus, the purchaser will be kept informed of the progress of the order.

The messages will also be sent to the customer service system.

The invention has been described in terms of preferred principles and embodiments, but those skilled in the art will recognize that variations may be made and equivalents substituted for what is described without departing from the scope and spirit of the invention as defined by the claims. For example, the portion of the tire selectable for customization may include the sidewall or a portion of the sidewall. A selectable feature for the sidewall may be a color band, a custom logo or words, or an ornamental design element. A color band or bands can be applied using an extruder as described above. Features like logos, words, or design elements may be pre-molded or pre-shaped, and applied to the sidewall by a robot or other similar piece handling apparatus. Alternatively, an extruder or applicator with a controllable, moveable head could be used to apply the logos, words, or design elements.

What is claimed is:

1. A method for ordering a customized tire and for manufacturing a customized tire using computer-based communication, comprising the steps of:
displaying a representation of a tire, the representation indicating at least one selectable portion of the tire for customization;
displaying selectable features for the at least one selectable portion;
accepting a customer selection of a selectable feature to apply to the at least one selectable portion;
accepting a customer communication to order a custom tire having the selected features;
generating an order in electronic form to purchase at least one custom tire having the selected features; and,
manufacturing a custom tire according to said order.

2. The method according to claim 1, further comprising the step of providing a visual representation of the selected feature applied to the selected portion responsive to the customer selecting a selectable feature for application to the at least one selectable portion.

3. The method according to claim 2, wherein the step of providing the visual representation includes graphically displaying a representation of the selected feature on the selected portion.

4. The method as claimed in claim 1, wherein the at least one selectable portion of the tire comprises a portion of the tread.

5. The method as claimed in claim 1, wherein the at least one selectable portion of the tire comprises a portion of the sidewall.

6. The method as claimed in claim 1, wherein the selectable features comprise a plurality of individually selectable colored tread rubbers.

7. The method as claimed in claim 1, wherein the selectable portion is the tread, and the selectable features comprise a plurality of performance characteristics.

8. The method as claimed in claim 1, further comprising the steps of displaying tire size selections and accepting a communication indicating a selected tire size for the order.

9. The method as claimed in claim 1, further comprising the step of accepting a communication indicating a selected tire model.

10. The method as claimed in claim 1, further comprising the steps of displaying a quantity selection and accepting a communication indicating a selected quantity for the tire order.

11. The method as claimed in claim 1, wherein portions of the tire identified as selectable remain selectable after a feature is applied until said communication to order the tire is received.

12. The method as claimed in claim 1, further comprising the step of accepting a communication link with a customer responsive to a request for a link prior to displaying the image of the tire.

13. The method as claimed in claim 1, wherein the step of manufacturing a custom tire comprises using the order in electronic form to control an automated manufacturing process.

14. The method as claimed in claim 13, further comprising the step of generating from the tire order a manufacturing specification for the tires of the order.

15. The method as claimed in claim 14, comprising the steps of:
providing a plurality of extruders, each extruder being dedicated for stripwinding one of a plurality of tire components, each component corresponding to one of the selectable features;
selecting, according to the manufacturing specification, an extruder having a component for the selected feature;
extruding and stripwinding the component for incorporation in an uncured tire; and
vulcanizing the tire.

16. The method as claimed in claim 15, wherein a plurality of features are selectable and the step of selecting an extruder includes selecting a plurality of extruders and the step of extruding and stripwinding includes sequentially extruding and stripwinding a component from each of the plurality of extruders.

17. A method for customizing a tire and ordering for manufacture a customized tire using computer-based communication, comprising the steps of:
displaying a representation of a tire tread, the representation indicating at least one user-selectable portion of the tread;
displaying a plurality of selectable colors for tread rubber;
accepting a customer selection of a color for tread rubber for the at least one selectable portion of the tread;
displaying a representation of the color applied to the selected tread portion;
accepting a customer communication to order a custom tire having the selected features;
generating an order in electronic form to purchase at least one custom tire having the selected color for the at least one selected portion of the tread; and
manufacturing a custom tire according to said order.

18. The method as claimed in claim 17, further comprising the steps of displaying tire size selections and requesting a communication indicating a selected tire size for the order.

19. The method as claimed in claim 17, further comprising the step of accepting a communication link with a customer prior to displaying the image of the tire.

20. The method as claimed in claim 17, wherein the step of manufacturing the custom tire includes using the order in electronic form to control an automated manufacturing process.

21. The method as claimed in claim 20, further comprising the step of generating from the custom tire order a manufacturing specification for the order.

22. The method as claimed in claim 21, comprising the steps of:
providing a plurality of extruders, each extruder being dedicated for stripwinding a tread rubber having one of a plurality of colors;
selecting according to the manufacturing specification an extruder having tread rubber having the selected color rubber;
extruding and stripwinding the tread rubber for incorporation in an uncured tire; and
vulcanizing the tire.

23. The method as claimed in claim 22, wherein a plurality of tread portions are selectable and the step of selecting an extruder includes selecting a plurality of extruders and the step of extruding and stripwinding includes sequentially extruding and stripwinding tread rubber from each of the plurality of extruders.
